(19) United States
(12) Patent Application Publication
(10) Pub. No.: US 2010/0327723 A1
(43) Pub. Date: Dec. 30, 2010

(54) LED ILLUMINATION DEVICE

(76) Inventor: Pei-Choa WANG, Gueishan Township (TW)

Correspondence Address: HDLS Patent & Trademark Services, P.O. BOX 220746, CHANTILLY, VA, 20153-0746, US

(21) Appl. No.: 12/492,238

(22) Filed: Jun. 26, 2009

(51) Int. Cl. H01J 1/02

(52) U.S. Cl. 313/12

(57) ABSTRACT

A light emitting diode (LED) illumination device includes a vapor chamber, a circuit board and at least one LED. At least one protrusion is formed on a surface of the vapor chamber, and a heat conducting tin layer is formed on the protrusion. The circuit board includes at least one through hole for passing the protrusion. The circuit board is formed by sequentially stacking an insulating layer and a heat conducting layer. The LEDs are installed on and contacted with the protrusions respectively, and each LED has two pins electrically connected to the circuit board. The LED device of the present invention is in a direct contact with the protrusion of the LED, such that the heat dissipated from the LED can be conducted to the vapor chamber, and then the vapor chamber carries away the heat quickly.

### BACKGROUND OF THE INVENTION

1. Field of the Invention

The present invention relates to an illumination device, and more particular to a light emitting diode (LED) illumination device.

2. Description of Prior Art

Light emitting diode (LED) has the power-saving and long-life features, and its brightness is improved continuously, and thus LED is applied to electronic devices and indoor or outdoor illumination lamps extensively.

Most indoor or outdoor illumination lamps combine a plurality of high brightness LEDs to form an LED lamp module to enhance the range and intensity of the illumination lamps. However, it is inevitable to increase the heat produced when the intensity of illumination is improved. In addition, the heat resistance of the LED, particularly for the high brightness LED, is lower than the heat resistance of a general incandescent light bulb. A high-temperature heat source not only causes heat to be accumulated around the LED and lowers the light emitting efficiency, but also affects the life of the LED, overheats the circuit board of the lamp, or damages the lamp. Therefore, a heat dissipating module is required to eliminate the high heat produced by the LED, so that the LED can emit light at a lower temperature. Thus, it is an important subject for illumination lamp manufacturers to dissipate the high heat produced by the LED timely and quickly to avoid the heat from affecting the efficiency and life of the LED.

However, in the design of a heat dissipating structure for most conventional LED lamps, a plurality of LED elements are installed on a circuit board first, and then the circuit board is assembled with a heat dissipating module including a heat dissipating fin, a heat pipe and a heat sink to carry away the heat. Since the overall volume of the lamp will be larger, and the heat of the LED element has to pass through the circuit board before reaching the heat sink of the heat dissipating module, therefore the heat conducting speed is low and the heat dissipating efficiency is poor.

### SUMMARY OF THE INVENTION

It is a primary objective of the present invention to provide an LED illumination device, wherein a heat source surface of an LED is attached directly to a vapor chamber, such that the heat produced by the LED can be absorbed by the vapor chamber directly and quickly, and carried away for the dissipation of the heat. The LED illumination device comprises a vapor chamber, a circuit board and at least one LED.

The vapor chamber includes a hollow metal casing, a capillary tissue attached onto an internal wall of the casing, and a working liquid filled into the casing. In addition, at least one protrusion is formed on a surface of the vapor chamber, and a heat conducting tin layer is disposed on the top of the protrusion for assisting the heat dissipation.

The circuit board includes at least one through hole for passing the protrusion, an insulating layer and a heat conducting layer, wherein the heat conducting layer is divided into a copper clad layer disposed at the top of the insulating layer, and a conducting tin layer disposed at the top of the copper clad layer.

The LEDs are surface mount LEDs in contact with the protrusions respectively, and each LED includes an LED die, a base, a heat conducting pillar passed and installed into the base and contacted with the LED die and the protrusion, and two conducting pins electrically connected to the heat conducting layer of the circuit board, wherein the LEDs are electrically connected in series.

The present invention makes use of the protrusions formed on the vapor chamber and in a direct contact with the heat conducting pillars of the LEDs, such that the heat produced by the LED dies can be conducted to the vapor chamber and carried away through the vapor chamber quickly. In addition, the vapor chamber has a smaller volume than the heat dissipating fin or the heat pipe and also has a better heat dissipating effect, and thus the invention can achieve the effects of reducing the number of LEDs, improving the attenuation of the light emitting efficiency, and extending the using life of the LEDs.

### BRIEF DESCRIPTION OF DRAWINGS

FIG. 1 is a perspective view of an LED illumination device of the present invention;

FIG. 2 is an exploded view of an LED illumination device of the present invention;

FIG. 3 is an cross-sectional view of an LED illumination device of the present invention; and

FIG. 4 is an enlarged view of Section A of FIG. 3.

### DETAILED DESCRIPTION OF THE INVENTION

The technical characteristics, features and advantages of the present invention will become apparent in the following detailed description of the preferred embodiments with reference to the accompanying drawings. The drawings are provided for reference and illustration only, but not intended for limiting the present invention.

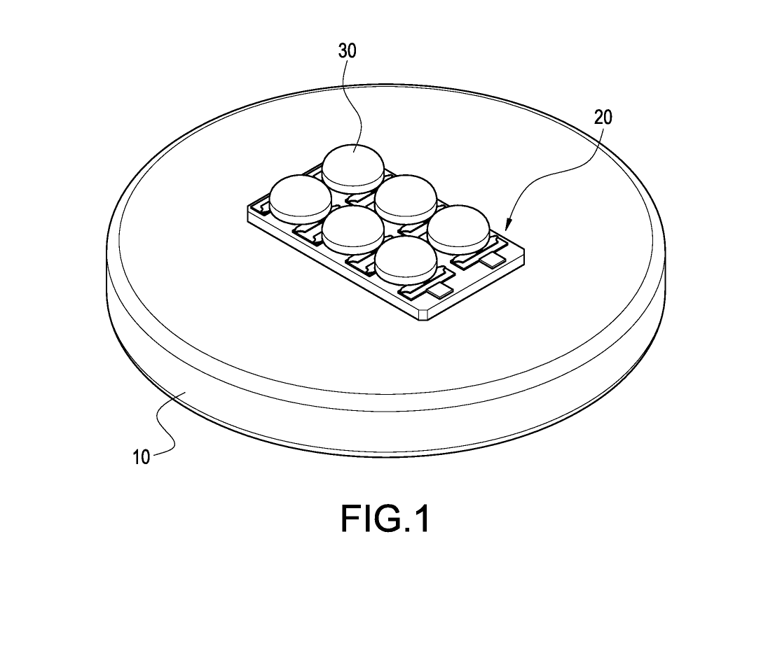

With reference to FIG. 1 for a perspective view of an LED illumination device of the present invention, the LED illumination device comprises a vapor chamber 10, a circuit board 20, and at least one LED 30.

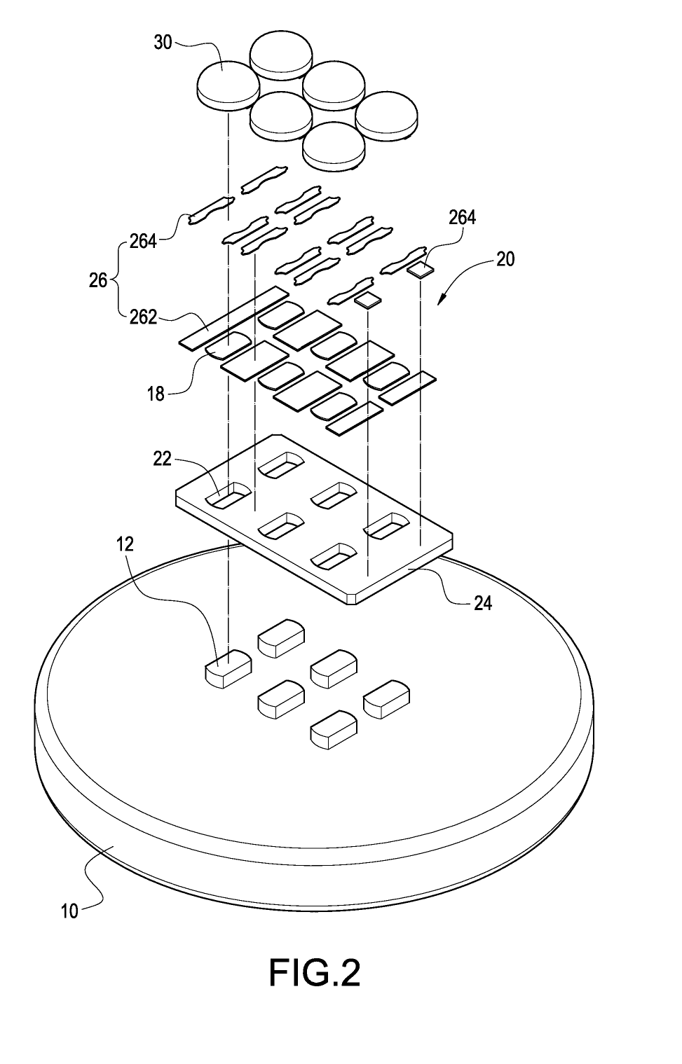

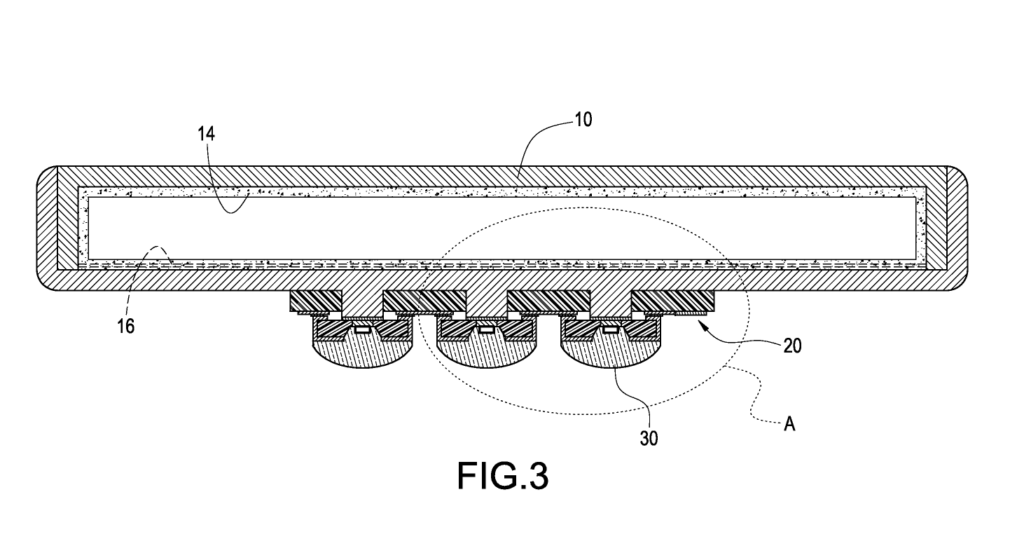

With reference to FIGS. 2 and 3 for an exploded view and a cross-sectional view of an LED illumination device of the present invention respectively, the vapor chamber 10 includes a hollow metal casing, a capillary tissue 14 attached onto an internal wall of the casing, and a working liquid 16 filled into the casing. In addition, at least one protrusion 12 is formed on a surface of the vapor chamber 10. In this preferred embodiment, the vapor chamber 10 adopts a circular casing, but the vapor chamber 10 can be in the shape of a square, a polygon, or any other irregular shape. The protrusion 12 includes a heat conducting tin layer 18 at the top for assisting the dissipation of heat.

The circuit board 20 includes at least one through hole 22 for passing the protrusion 12 through the through hole 22. The circuit board 20 includes an insulating layer 24 and a heat conducting layer 26, wherein the heat conducting layer 26 can be divided into a copper clad layer 262 disposed on the top of the insulating layer 24 and a conducting tin layer 264 disposed at the top of the copper clad layer 262.

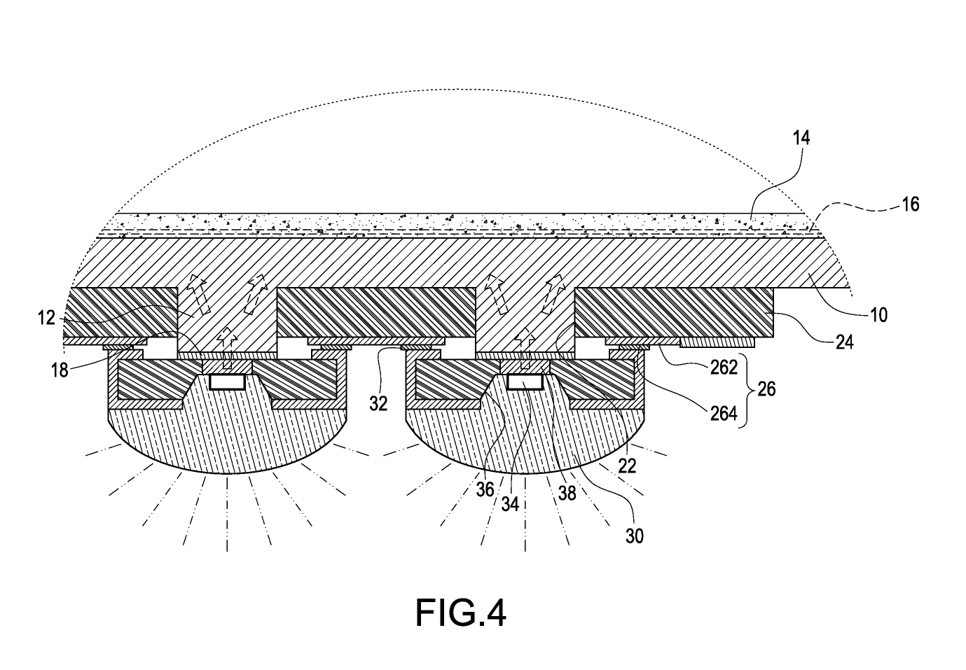

With reference to FIG. 4, the LEDs 30 are surface mount LEDs installed onto and contacted with the protrusions 12 respectively. Each LED 30 includes conducting pins 32, an LED die 34, a base 36, and a heat conducting pillar 38 passed and installed into the base 36 and contacted with the LED die 34 and the protrusion 12, wherein a thin layer of solder is coated onto the bottom of the LED 30 and can be combined with the conducting tin layer 18 of the protrusion 12 by a hot soldering method, and a solder paste is coated to the bottom of the two conducting pins 32 and the two conducting pins 32 are connected and combined with the conducting tin layer 264 of the circuit board 20 by the hot soldering method, and the LEDs 30 are electrically connected in series. The heat conducting pillar 38 is attached flatly onto the heat conducting tin layer 18 of the protrusion 12 for conducting the heat produced by the LED die 34 to the vapor chamber 10 through the protrusion 12 in contact with the heat conducting pillar 38.

In an actual operation, the LEDs 30 will be lit when the LED illumination device is turned on, and the LED dies 34 inside the LED 30 will start produce heat. The heat produced by the LED die 34 is conducted to the heat conducting pillar 38 through the base 36, and then conducted from the heat conducting pillar 38 to the heat conducting tin layer 18 at the top of the protrusion 12, and finally conducted to a side of the vapor chamber 10 through the protrusion 12 formed on the vapor chamber 10, so as to constitute a high temperature side, wherein the high temperature side is a side having the installed LED 30.

If the vapor chamber 10 receives the heat produced by the LED dies 34, the working liquid 16 inside the vapor chamber 10 will absorb the heat for vaporization to convert the working liquid 16 into a gaseous state. The gas carrying the heat will be transmitted to another side of the vapor chamber 10 by convection to form a low temperature side. Since the temperature of the low temperature side is lower than the high temperature side, therefore the gas carrying the heat will start condensing and turn back into the form of a working liquid, and the working liquid flows back to the high temperature side through the capillary tissue 14 at the internal wall of the vapor chamber 10. The vapor chamber 10 dissipates the heat produced by the LED dies 34 through repeated vaporizations and condensations.

Since the vapor chamber is a passive heat dissipating device requiring no consumption of energy sources to achieve the heat dissipating effect, and the vapor chamber is a flat sheet structure having a larger heat conducting area than a conventional heat pipe, therefore the vapor chamber can dissipate heat from the heat source much faster.

In summation of the description above, the present invention makes use of the protrusions 12 formed on the vapor chamber 10 and in a direct contact with the heat conducting pillar 38 of the LEDs 30 to conduct the heat produced by the LED dies 34 to the vapor chamber 10 quickly, and carries the heat away by the vapor chamber 10. Compared with a conventional LED device that has to pass heat through a circuit board before reaching a heat dissipating module, the present invention has a better heat dissipating efficiency. In addition, the vapor chamber 10 has a smaller volume than that of the heat dissipating fin or heat pipe, and a better heat dissipating effect, and thus the present invention can achieve the effects of reducing the number of LED, enhancing the light emitting efficiency of the LEDs, and extending the using life of the LEDs.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A light emitting diode (LED) illumination device, comprising:
a vapor chamber, including a hollow metal casing, a capillary tissue attached onto an internal wall of the casing, a working liquid filled into the casing, and at least one protrusion formed on a surface of the vapor chamber;
a circuit board, having at least one through hole, for passing the corresponding protrusion; and
at least one LED, installed onto and contacted with the corresponding protrusion, and each LED having two pins electrically connected to the circuit board.

2. The LED illumination device of claim 1, wherein the LED includes a base, an LED die disposed on the base, and a heat conducting pillar installed to the base and contacted with the LED die and the protrusion.

3. The LED illumination device of claim 2, further comprising a heat conducting tin layer disposed between the protrusion and the heat conducting pillar.

4. The LED illumination device of claim 1, wherein the circuit board includes an insulating layer and a heat conducting layer disposed at the top of the insulating layer.

5. The LED illumination device of claim 4, wherein the heat conducting layer includes a copper clad layer disposed at the top of the insulating layer, and a conducting tin layer disposed on a surface of the copper clad layer.

6. The LED illumination device of claim 1, wherein the LEDs are surface mount LEDs.

7. The LED illumination device of claim 1, wherein the LEDs are electrically connected in series.
